(19) United States
(12) Patent Application Publication
(10) Pub. No.: US 2024/0224829 A1
(43) Pub. Date: Jul. 11, 2024

(54) ROW CLEANER BLADE

(71) Applicant: Osmundson Mfg. Co., Perry, IA (US)

(72) Inventor: Douglas G. Bruce, West Des Mounes, IA (US)

(21) Appl. No.: 18/410,878

(22) Filed: Jan. 11, 2024

Related U.S. Application Data
(60) Provisional application No. 63/438,302, filed on Jan. 11, 2023.

(51) Int. Cl. A01B 35/28

(52) U.S. Cl. CPC A01B 35/28

(57) ABSTRACT

An agricultural row cleaner blade, comprising a plurality of projections having a rounded end extending from an outer periphery and a plurality of depressions having a rounded inside edge. The agricultural row cleaner blade wherein each of the plurality of projections are disposed at an angle between 60° and 90° relative to a tangent of a circle at the outer periphery.

### CROSS-REFERENCE TO RELATED APPLICATION(S)

This application claims the benefit under 35 U.S.C. § 119(e) to U.S. Provisional Application 63/438,302, filed on Jan. 11, 2023, and entitled “Improved Row Cleaner Disc”, which is hereby incorporated herein by reference in its entirety for all purposes.

### TECHNICAL FIELD

The disclosure relates to agricultural implements and in certain implementations to row cleaners, also referred to as trash wheels, and discs/blades/wheels for use thereon.

### BACKGROUND

Row cleaners and various discs/blades/wheels for use thereon are known in the art. Various of these known discs/blades/wheels are configured such that trash will accumulate on the device reducing the effectiveness of the row cleaner over time.

There is a need in the art for improved discs/blades/wheels for moving trash away from a planting implement such that trash will not impede planting and plant growth.

### BRIEF SUMMARY

Disclosed herein are various discs/blades/wheels for use on an agricultural row cleaner or trash wheel. In various implementations the discs/blades/wheels are configured to tear/rip trash rather than pick trash up. That is, the discs/blades/wheels rake the trash away from the planting area rather than impaling or retaining trash on the discs/blades/wheels itself.

In various implementations the discs/blades/wheels disclosed herein are configurable for use with different soil types, including adjustments to the angles of the prongs and/or the curvature of the discs/blades/wheels. The discs/blades/wheels are configured for planting population security.

While multiple embodiments are disclosed, still other embodiments of the disclosure will become apparent to those skilled in the art from the following detailed description, which shows and describes illustrative embodiments of the invention. As will be realized, the disclosure is capable of modifications in various obvious aspects, all without departing from the spirit and scope of the disclosure. Accordingly, the drawings and detailed description are to be regarded as illustrative in nature and not restrictive.

In Example 1, an agricultural row cleaner blade, comprising a plurality of projections having a rounded end extending from an outer periphery, and a plurality of depressions having a rounded inside edge.

In Example 2, the agricultural row cleaner blade of claim 1, wherein each of the plurality of projections are disposed at an angle between about 60° and about 90° relative to a tangent of a circle at the outer periphery.

In Example 3, the agricultural row cleaner blade of claim 1, further comprising one or more openings configured for mounting the agricultural row cleaner blade on an implement.

In Example 4, the agricultural row cleaner blade of claim 1, wherein the rounded end has a radius of about ⅜″ to about ¾″.

In Example 5, the agricultural row cleaner blade of claim 1, wherein the rounded end has a radius of about ½″.

In Example 6, the agricultural row cleaner blade of claim 1, wherein the rounded end is a dual rounded end.

In Example 7, the agricultural row cleaner blade of claim 1, wherein the number of projections equals the number of depressions.

In Example 8, the agricultural row cleaner blade of claim 1, wherein the agricultural row cleaner blade is flat.

In Example 9, the agricultural row cleaner blade of claim 1, wherein the agricultural row cleaner blade is convex.

In Example 10, the agricultural row cleaner blade of claim 1, wherein the agricultural row cleaner blade is concave.

In Example 11, a system for cleaning a field comprising a row cleaning implement, and a plurality of agricultural row cleaner blades rotatably attached to the row cleaning implement, each comprising a plurality of projections having a rounded end extending from an outer periphery, and a plurality of depressions having a rounded inside edge.

In Example 12, the system of claim 11, wherein the plurality of agricultural row cleaner blades comprises a single blade.

In Example 13, the system of claim 11, wherein the plurality of agricultural row cleaner blades comprises two blades.

In Example 14, the system of claim 11, wherein the plurality of agricultural row cleaner blades comprises three blades.

In Example 15, a method of removing debris from a field comprising passing over the field a plurality of agricultural row cleaner blades comprising a plurality of projections having a rounded end extending from an outer periphery, and a plurality of depressions having a rounded inside edge.

In Example 16, the method of claim 15, wherein each of the plurality of projections are disposed at an angle between about 60° and about 90° relative to a tangent of a circle at the outer periphery.

In Example 17, the method of claim 15, further comprising one or more openings configured for mounting the agricultural row cleaner blade on an implement.

In Example 18, the method of claim 15, wherein the rounded end has a radius of about ⅜″ to about ¾″.

In Example 19, the method of claim 15, wherein the rounded end has a radius of about ½″.

In Example 20, the method of claim 15, wherein the rounded end is a dual rounded end.

### BRIEF DESCRIPTION OF THE DRAWINGS

FIG. 1 shows a schematic of the agricultural row cleaner blade with different projection angles, according to one implementation.

FIG. 2 shows a schematic of the agricultural row cleaner blade viewed from the side, according to one implementation.

FIG. 3 shows a schematic of the agricultural row cleaner blade viewed edge-on, according to one implementation.

FIG. 4 shows a perspective view of the agricultural row cleaner blade viewed edge-on, according to one implementation.

FIG. 5 shows a schematic of the agricultural row cleaner blade with additional openings viewed from the side, according to one implementation.

FIG. 6 shows a schematic of the agricultural row cleaner blade with additional openings viewed edge-on, according to one implementation.

FIG. 7 shows a perspective view of the agricultural row cleaner blade with additional openings viewed edge-on, according to one implementation.

FIG. 8 shows a schematic of the agricultural row cleaner blade with additional openings viewed from the side, according to one implementation.

FIG. 9 shows a schematic of the agricultural row cleaner blade with additional openings viewed edge-on, according to one implementation.

FIG. 10 shows a perspective view of the agricultural row cleaner blade with additional openings viewed edge-on, according to one implementation.

FIG. 11 shows a schematic of the agricultural row cleaner blade with additional openings viewed from the side, according to one implementation.

FIG. 12 shows a schematic of the agricultural row cleaner blade with additional openings viewed edge-on, according to one implementation.

FIG. 13 shows a perspective view of the agricultural row cleaner blade with additional openings viewed edge-on, according to one implementation.

### DETAILED DESCRIPTION

Disclosed herein are various implementations and configuration of an agricultural blade/plate/wheel. Various of these blades/plates/wheels are for use with an agricultural row cleaner (also referred to as trash wheels). As would understood by those of skill in the art, agricultural row cleaners are designed to move or remove trash from a field or planting row prior to planting. The purpose of removing or moving trash is to prevent the trash from disrupting plant emergence and/or interfering with efficient and consistent planting.

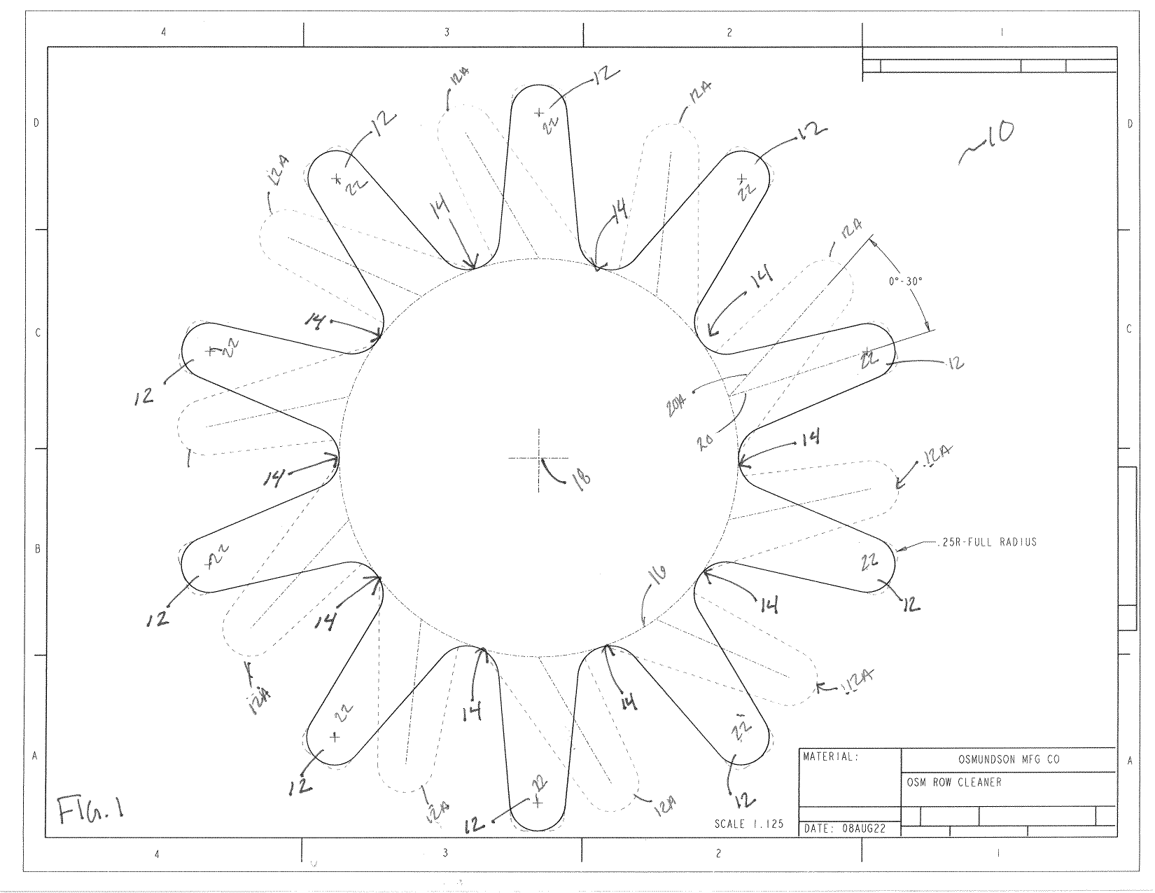

FIG. 1 shows a flat agricultural blade 10 (also referred to herein as a “disc,” a “wheel,” or a “cleaner wheel”) that has a plurality of projections 12 along the outer periphery 16 and a corresponding number of depressions 14 between the projections 12. In certain implementations, the blade 10 includes ten projections 12 and ten depressions 14. As can be seen in FIG. 1 the projections 12 and depressions 14 are equal in size and evenly distributed about the blade 10.

In various implementations, the blade 10 includes a center opening 18. The center opening 18 may be configured for mounting the blade 10 on a row cleaner or other implement via any appreciated mounting technique, as would be understood by those of skill in the art. Alternative or additional opening may be provided in the blade 10 for various mounting techniques, such as a bracket or bearing structure.

Continuing with FIG. 1, the projections 12 may be disposed at a variety of angles relative to the outer periphery 16. In various implementations, the projections 12 may extend straight out (at a 0° angle from perpendicular) from the outer periphery 16. That is, the center line 20 of the projection 12 may be perpendicular to a tangent of the outer periphery 16 at the point where the center line 20 meets the outer periphery. In alternative implementations, shown with the dashed projections 12A the projections may be at an angle relative to the outer periphery 16. That is, the angled center line 20A of the projections 12A intersects the tangent of the outer periphery 16 at a 60° angle (a 30° difference from a perpendicular implementation). As would be appreciated the angle of the projections 12, 12A could be any angle, but is likely between a 90° and 60° angle relative to the tangent of the outer periphery 16 at the point where the center line of the projection 12, 12A meets the outer periphery 16.

The selection of the angle of the projections 12, 12A on a particular blade 10 may correspond to the type of soil the blade 10 is intended to be used in and/or the type of crop residue/trash likely to be encountered. Exemplary crop residues include corn, soybean, sugar cane, vegetable residues. Different soil types may include loose, sandy soil; rocky soil that is hard to rake; clay soil is sticky to self-clean; loose soil that can handle more speed.

Additionally, the blades 10 may have projections 12, 12A disposed at varying angles for the intended aggressiveness or gentleness of the implement. For example, different implement manufacturers may have different designs to make the equipment more or less gentle, as would be appreciated. For example, an aggressive configuration is likely to leave rougher residue to plant through and may be best for corn, soybeans, sugar cane, or another appreciated crop. As would also be appreciated, a gentle configuration may be more suitable for table vegetables or sandy soil conditions. As would be appreciated, a gentle configuration would in which angled center line 20A of the projection 12A intersects the tangent of the outer periphery 16 at an angle, and the projection 12A angles against to direction of rotation of the blade 10 in operation. As would also be appreciated, an aggressive configuration would in which angled center line 20A of the projection 12A intersects the tangent of the outer periphery 16 either about perpendicularly, or at an angle where the projection 12A angles toward to direction of rotation of the blade 10 in operation. As would be understood, a blade 10 with angled projections 12, 12A could be used as either an aggressive or gentile blade 10 depending on its direction of mounting and rotation.

Further implementations of the projections 12 have a rounded end 22. These projections 12 are configured with rounded ends 22 because rounded ends 22 do not pick up trash, but rather tears the trash such that the trash falls off the projections 12 and blade 10. By tearing the trash removal from the planting area is possible and the efficiency of the row cleaner is improved.

In various implementations, the projections 12 can be of various lengths. In certain implementations, the projections 12 can range from about 1 ¾″ to about 4″ or more, or any length in between. In various implementations, the projections 12 can be greater than about 4″ long, including up to about 6″ or 10″ or more, or can be less than 1 ¾″ long.

In various implementations, the radius of the rounded end 22 is about ⅜″ to about ¾″. In certain implementations, a radius of less than ⅜″ the projections 12 can tend to impale trash, acting much like a pointed end, and thereby retain it on the blade 10. With a rounded end 22 radius of more than ¾″ the projections 12 can tend to not rake or clean a pathway for planting, which may disrupt plant emergence or cause inconsistent planting among other disadvantages that would be recognized. In certain implementations, the radius of the rounded end 22 is ½″. In alternate settings, however, the radius can be less than about ⅜″ or more than about ¾″, ranging from small fractions of an inch (less than about ¼″) to about 1″ or more, depending on the specific application.

As also shown in FIG. 1, the inside edge of the depression 14 is also rounded so that dirt does not get packed in the corners of a square depression or a tight radius. The radius of the depression 14 may vary depending on the angle and width of the projection 12, as would be understood.

In certain implementations, the blade 10 may be a variety of curvatures ranging from flat to convex or concave. A flat blade 10 will clean faster with less trash attaching to the blade 10. A flat blade 10 may leave an inconsistent surface adequate for shallower planting depths. A curved (convex or concave) blade 10 will mix soil and make a looser seed bed during operation. Curved implementations may be used for consistent depth in certain soils to achieve uniform growth starts.

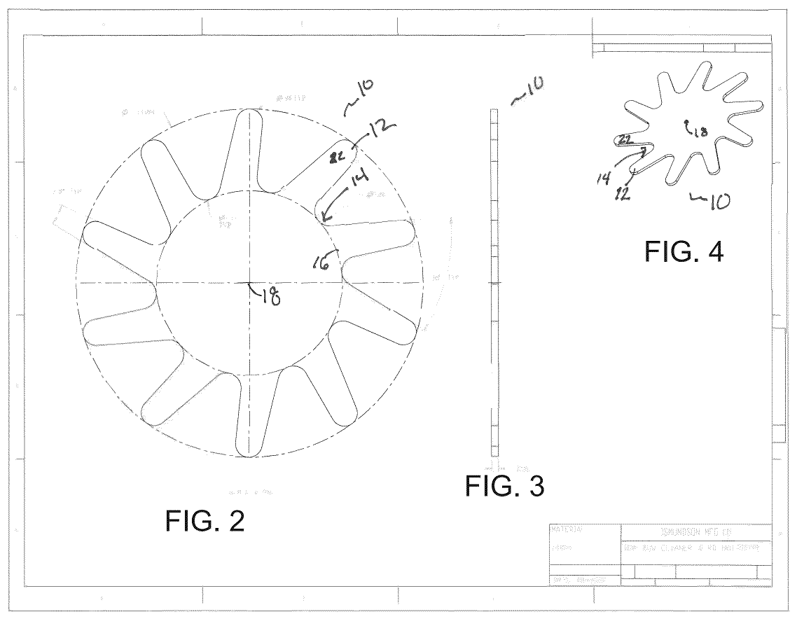

FIGS. 2-4 show a further implementation of the blade 10 from multiple perspectives. In these implementations, the projections 12 are at an angle and the blade is flat (seen best in FIG. 4).

In various implementations, a row cleaner may include multiple blades 10 running together. For example, a triple blade 10 row cleaner may include three blades 10 grouped together. In certain of these implementations, the individual blades 10 may have different projection 12 angles, for example one blade with a 90° angle for the projections, a second blade 10 with a 75° angle for the projections, and a third blade 10 with a 60° angle for the projections. Various alternative combinations and configuration are possible and would be appreciated.

As would be appreciated, a triple set of blades 10 on the row cleaner is the most common but single and double blades 10 set ups are possible especially with equipment where space is an issue. Various configurations would be appreciated by those of skill in the art.

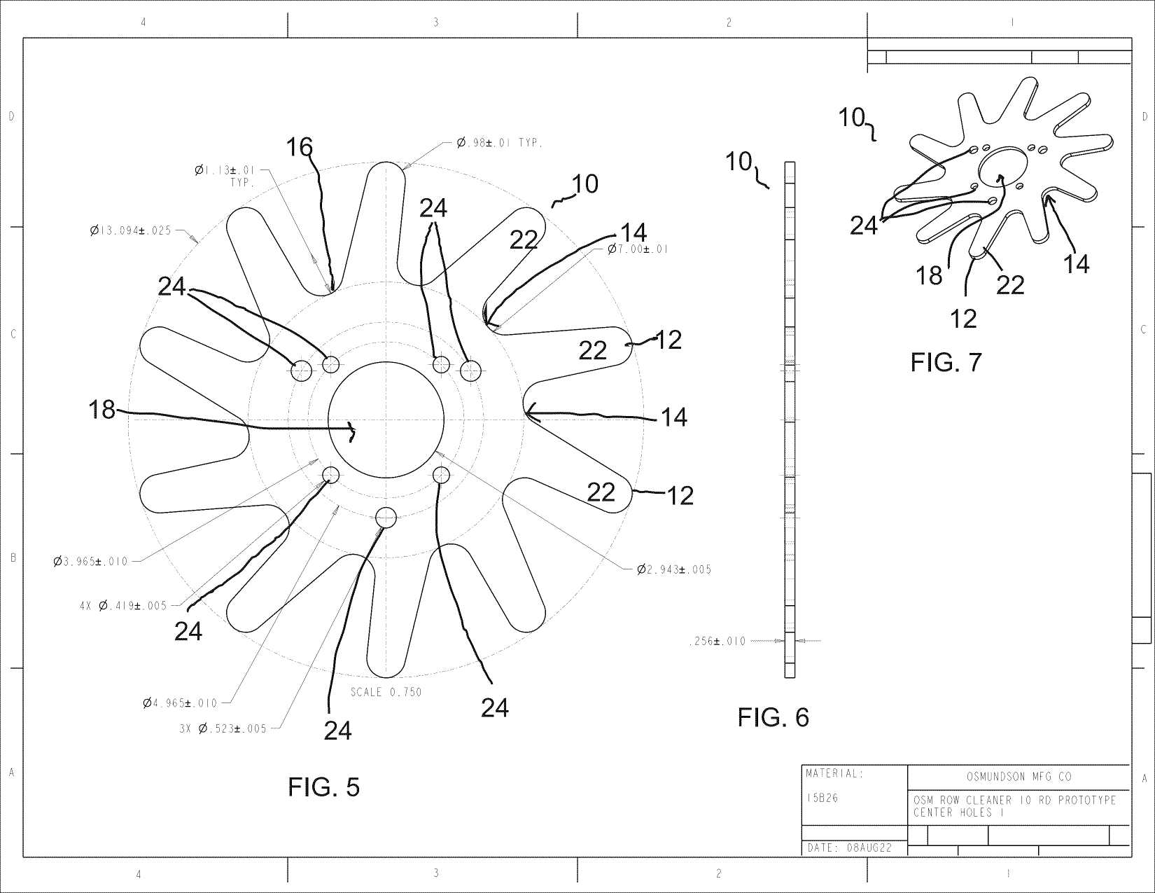

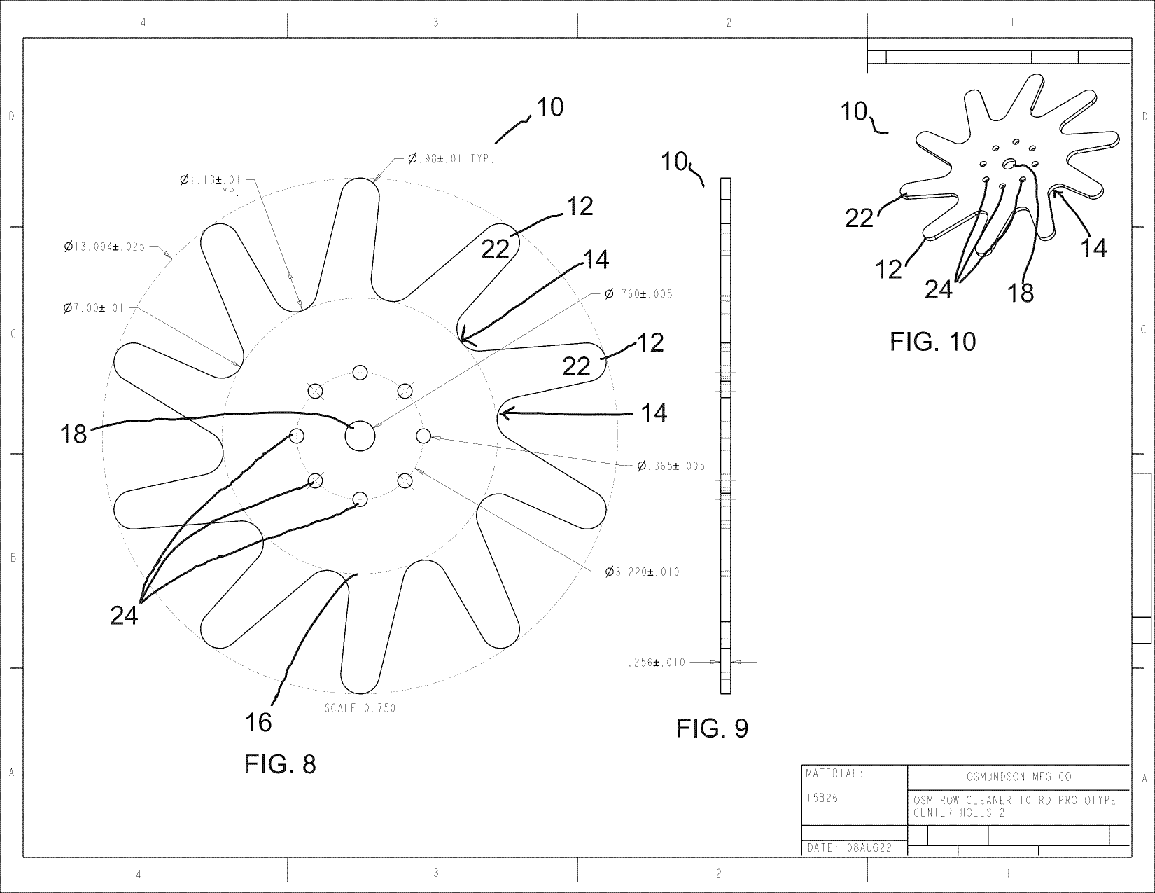

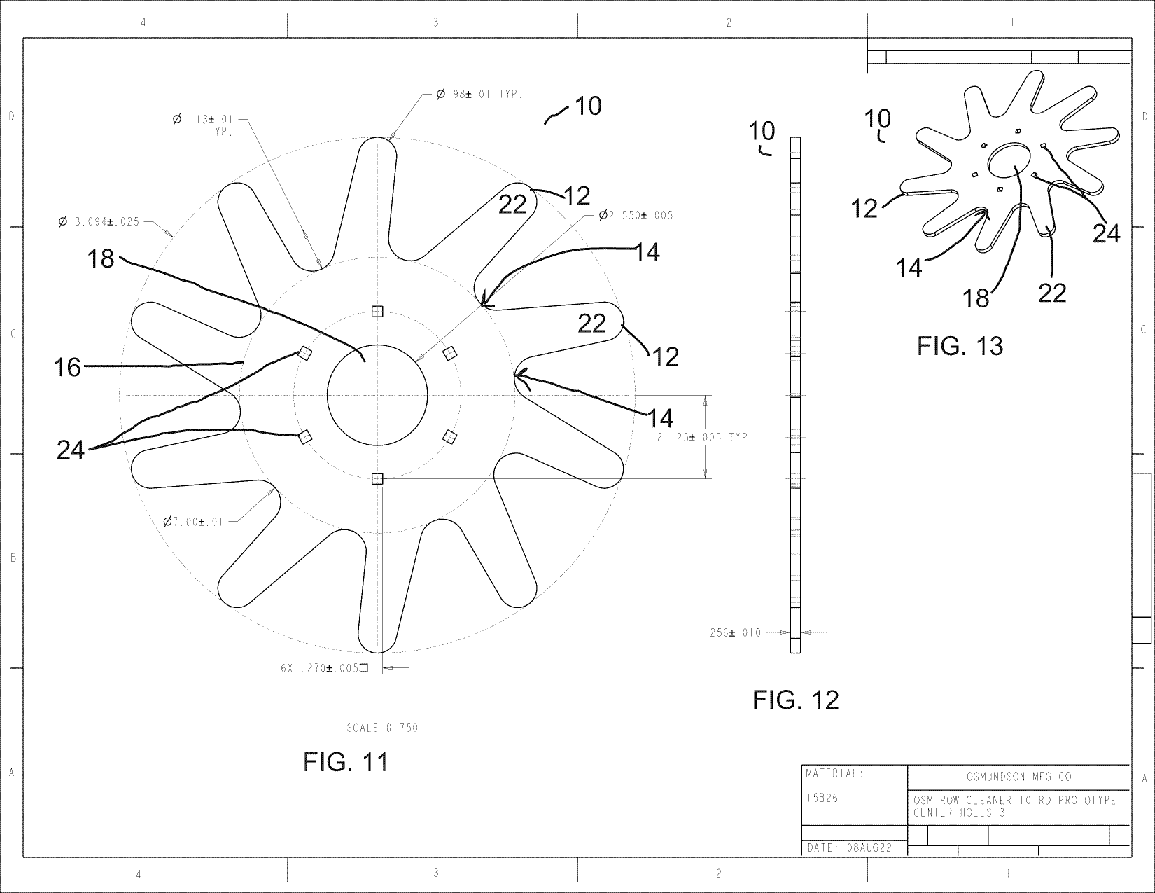

FIGS. 5-13 shows various further implementations of the blade 10. In addition to the center opening 18, the blade 10 may include various additional openings 24 for mounting the blade 10 to a row cleaner or other implement. As previously noted, the blade 10 may be mounted via any appreciated mounting technique, as would be understood by those of skill in the art. The openings 24 shown variously in FIGS. 5-13 may be configured for cooperation with a bracket or bearing structure having a corresponding pattern, as would be well-understood.

Although the disclosure has been described with references to various embodiments, persons skilled in the art will recognize that changes may be made in form and detail without departing from the spirit and scope of this disclosure.

What is claimed is:

1. An agricultural row cleaner blade, comprising:
(a) a plurality of projections having a rounded end extending from an outer periphery; and
(b) a plurality of depressions having a rounded inside edge.

2. The agricultural row cleaner blade of claim 1, wherein each of the plurality of projections are disposed at an angle between about 60° and about 90° relative to a tangent of a circle at the outer periphery.

3. The agricultural row cleaner blade of claim 1, further comprising one or more openings configured for mounting the agricultural row cleaner blade on an implement.

4. The agricultural row cleaner blade of claim 1, wherein the rounded end has a radius of about ⅜″ to about ¾″.

5. The agricultural row cleaner blade of claim 1, wherein the rounded end has a radius of about ½″.

6. The agricultural row cleaner blade of claim 1, wherein the number of projections equals the number of depressions.

7. The agricultural row cleaner blade of claim 1, wherein the agricultural row cleaner blade is flat.

8. The agricultural row cleaner blade of claim 1, wherein the agricultural row cleaner blade is convex.

9. The agricultural row cleaner blade of claim 1, wherein the agricultural row cleaner blade is concave.

10. A system for cleaning a field comprising:
(a) a row cleaning implement; and
(b) a plurality of agricultural row cleaner blades rotatably attached to the row cleaning implement, each comprising:
(i) a plurality of projections having a rounded end extending from an outer periphery; and
(ii) a plurality of depressions having a rounded inside edge.

11. The system of claim 10, wherein the plurality of agricultural row cleaner blades comprises a single blade.

12. The system of claim 10, wherein the plurality of agricultural row cleaner blades comprises two blades.

13. The system of claim 10, wherein the plurality of agricultural row cleaner blades comprises three blades.

14. A method of removing debris from a field comprising:
passing over the field a plurality of agricultural row cleaner blades comprising
a plurality of projections having a rounded end extending from an outer periphery; and
a plurality of depressions having a rounded inside edge.

15. The method of claim 14, wherein each of the plurality of projections are disposed at an angle between about 60° and about 90° relative to a tangent of a circle at the outer periphery.

16. The method of claim 14, further comprising one or more openings configured for mounting the agricultural row cleaner blade on an implement.

17. The method of claim 14, wherein the rounded end has a radius of about ⅜″ to about ¾″.

18. The method of claim 14, wherein the rounded end has a radius of about ½″.

19. The method of claim 14, wherein the plurality of agricultural row cleaner blades comprise a plurality of aggressive projections.

20. The method of claim 14, wherein the plurality of agricultural row cleaner blades comprise a plurality of gentle projections.
